(19) United States
(12) Patent Application Publication
(10) Pub. No.: US 2026/0002954 A1
(43) Pub. Date: Jan. 1, 2026

(54) SAMPLE HANDLING ARRANGEMENT

(71) Applicant: Beckman Coulter, Inc., Brea, CA (US)

(72) Inventors: Shigeru FUJII, Nagaizumi-cho (JP); Laura Elizabeth Schilling HOLMES, Minnetonka, MN (US); Jon P. LINDQUIST, Jr., Coon Rapids, MN (US); Kazuki UMEBARA, Nagaizumi-cho (JP)

(21) Appl. No.: 18/879,743

(22) PCT Filed: Jun. 26, 2023
(86) PCT No.: PCT/US2023/026201

§ 371 Date: Dec. 27, 2024

Related U.S. Application Data
(60) Provisional application No. 63/356,026, filed on Jun. 27, 2022.

(51) Int. Cl. G01N 35/04; G01N 35/02; G01N 35/10

(52) U.S. Cl. CPC G01N 35/04; G01N 35/025; G01N 35/1011; G01N 2035/0415

(57) ABSTRACT

The present disclosure provides a sample handling arrangement (100, 100′, 100″) for transferring one or more patient samples or portions thereof from at least one sample tube (20) to at least one reaction vessel (22) within an automated analyzer (50, 50′). The sample handling arrangement (100, 100′, 100″) includes a sample presentation unit (102) associated with the automated analyzer (50) and configured to receive a plurality of racks (26) into the automated analyzer (50). Each of the plurality of racks (26) is configured to receive and hold the at least one sample tube (20). The sample handling arrangement (100, 100′, 100″) further includes a linear slide (114) configured to be selectively mounted to a mount of the automated analyzer (50) at a first position (P1) and a second position (P2) different from the first position (P2). The sample handling arrangement (100, 100′, 100″) further includes a pipetting module (112) configured to travel along the linear slide (114) and transfer the one or more patient samples or portions thereof to the at least one reaction vessel (22) within the automated analyzer (50, 50′).

### PRIORITY

This application claims the benefit of U.S. Pat. App. No. 63/356,026, entitled “Sample Handling Arrangement,” filed Jun. 27, 2022, the disclosure of which is incorporated by reference herein.

### FIELD

The present disclosure generally relates to a sample handling arrangement. More particularly, the present disclosure relates to a sample handling arrangement for transferring one or more patient samples or portions thereof from at least one sample tube to at least one reaction vessel within an automated analyzer.

### BACKGROUND

A number of different clinical analyzers are known in the art. Such analyzers range from simple, largely manually operated instruments to highly complex, nearly fully automated instruments. Each analyzer has its own performance characteristics related to the number of different tests (“menu”) that the analyzer can perform and the number of samples that the analyzer can process in a given period of time (“throughput”). Automated analyzers have been developed to increase the efficiency of testing procedures by reducing turnaround time and decreasing the volumes necessary to perform various assays. There is a provision for transferring the samples or other fluids within the automated analyzers, particularly to dispense the samples into reaction vessels. A configuration of the automated analyzer in which the samples are transferred from one place to another within the automated analyzer may be called a standalone configuration of the automated analyzer.

However, in some cases, there is a demand or need for transferring a fluid (i.e., blood, serum, plasma, urea samples, reagents, or other biological fluids) from an external track (e.g., a moving conveyor in a laboratory but outside the automated analyzer) to the reaction vessels within the automated analyzer. Many of the categories of automated analyzers may not include an in-built mechanism to transfer the samples (or other fluids) from the external track to the reaction vessels within the automated analyzers. Some categories of the automated analyzers may enable such transfer of the samples by installing additional components (e.g., an additional conveying line, connectors, and so on) so as to mechanically couple the automated analyzer with the external track. In some instances, an additional pipetting mechanism may be required for aspirating the samples from the external track and dispense those into transfer modules within the automated analyzer and subsequently into the reaction vessels within the automated analyzer. A configuration of the automated analyzer in which the samples are transferred from the external track to the reaction vessels within the automated analyzer may be called an external configuration of the automated analyzer.

The installation of additional components on the automated analyzer for transferring the samples from the external track to the reaction vessels within the automated analyzer may increase an overall cost of operation of the automated analyzer. Further, the additional components for transferring the samples from the external track to the automated analyzer may reduce a throughput speed of the automated analyzer, thereby leading to inefficient analysis of the samples.

Moreover, once the additional components are installed on the automated analyzer to set automated analyzer in the external configuration, it may be difficult to switch the automated analyzer quickly and efficiently back to the standalone configuration as this would require unloading and/or uninstallation of some of the additional components that were earlier installed for setting the automated analyzer in the external configuration. Therefore, switching the operation of the automated analyzer between the standalone configuration and the external configuration may be a time-consuming process which can ultimately reduce the efficiency and the throughput speed of the automated analyzer. Hence, switching an automated analyzer between the standalone configuration and the external configuration may not be feasible.

### BRIEF SUMMARY

According to a first aspect of the disclosure, a sample handling arrangement is provided for transferring at least a portion of one or more patient samples from at least one sample tube to at least one reaction vessel within an automated analyzer. The sample handling arrangement comprises a sample presentation unit associated with the automated analyzer and configured to receive a plurality of racks into the automated analyzer. Each of the plurality of racks is configured to receive and hold the at least one sample tube. The sample handling arrangement further comprises a linear slide configured to be selectively mounted to a mount of the automated analyzer at a first position and a second position different from the first position. The sample handling arrangement further comprises a pipetting module configured to transfer at least the portion of the one or more patient samples to the at least one reaction vessel within the automated analyzer. The pipetting module is configured to travel along the linear slide. The sample handling arrangement further comprises a rack transfer module operatively coupled to the sample presentation unit and configured to transfer at least one rack of the plurality of racks from the sample presentation unit to the pipetting module within the automated analyzer. The sample handling arrangement further comprises a home sensor for sensing the presence or absence of the pipetting module at a home position. The pipetting module is operable in a first mode in which the pipetting module is configured to transfer at least the portion of the one or more patient samples from the at least one sample tube held by the at least one rack within the automated analyzer to the at least one reaction vessel within the automated analyzer. The pipetting module is further operable in a second mode in which the pipetting module is configured to transfer at least the portion of the one or more patient samples from an external track disposed outside the automated analyzer to the at least one reaction vessel within the automated analyzer. The sample handling arrangement is operable in a first configuration in which the pipetting module is configured to travel within the automated analyzer and thereby operate solely in the first mode. The sample handling arrangement is further operable in a second configuration in which the pipetting module is configured to travel within the automated analyzer and to the external track and thereby operate in the second mode. In the second configuration of the sample handling arrangement, the pipetting module is further configured to travel within the automated analyzer and to the at least one rack transferred by the rack transfer module within the automated analyzer and thereby also operate in the first mode. The linear slide is configured to be mounted to the mount of the automated analyzer at the first position when the sample handling arrangement is operating in the first configuration. The linear slide is configured to be mounted to the mount of the automated analyzer at the second position when the sample handling arrangement is operating in the second configuration. The linear slide is configured to be stationary when the sample handling arrangement is operating in each of the first configuration and the second configuration.

According to an embodiment of the sample handling arrangement of the first aspect, a physical location of the home sensor is configured to be unchanged when the sample handling arrangement is operating in the first configuration as well as when the sample handling arrangement is operating in the second configuration.

According to an embodiment of the sample handling arrangement of the first aspect, the rack transfer module further comprises a linear transport line configured to receive the at least one rack from the sample presentation unit. The rack transfer module further comprises a rack rotor configured to transfer the at least one rack from the linear transport line to the pipetting module within the automated analyzer.

According to an embodiment of the sample handling arrangement of the first aspect, the pipetting module and the rack transfer module travel linearly and perpendicularly to each other.

According to an embodiment of the sample handling arrangement of the first aspect, the sample handling arrangement further comprises the external track. The pipetting module and the external track are configured to travel perpendicularly to each other adjacent to a point of intersection of the pipetting module and the external track.

According to an embodiment of the sample handling arrangement of the first aspect, the linear slide is configured to be dismounted at one of the first position and the second position and subsequently mounted at the other of the first position and the second position in order to switch operation of the sample handling arrangement between the first configuration and the second configuration.

According to an embodiment of the sample handling arrangement of the first aspect, the sample handling arrangement further comprises a position selector configured to selectively position and mount the linear slide at either the first position or the second position.

According to an embodiment of the sample handling arrangement of the first aspect, the mount comprises a rail along which the linear slide is configured to be positioned at either the first position or the second position. The linear slide is configured to be secured to the rail when the sample handling arrangement is operating in each of the first configuration and the second configuration.

According to an embodiment of the sample handling arrangement of the first aspect, the pipetting module further comprises a carriage configured to travel along the linear slide. The linear slide further comprises a first portion and a second portion. The carriage is configured to travel on the first portion and the second portion of the linear slide when the sample handling arrangement is operating in the second configuration. The carriage is not configured to travel on the second portion of the linear slide when the sample handling arrangement is operating in the first configuration, such that the second portion defines an unused (i.e., non-used) portion of the linear slide in the first configuration of the sample handling arrangement.

According to an embodiment of the sample handling arrangement of the first aspect, the home sensor is configured to be positioned along the second portion of the linear slide when the sample handling arrangement is operating in the second configuration.

According to an embodiment of the sample handling arrangement of the first aspect, the first portion of the linear slide extends from the home sensor towards a location for the external track when the sample handling arrangement is operating in the first configuration. Further, the second portion of the linear slide extends from adjacent the home sensor opposite to the first portion when the sample handling arrangement is operating in the first configuration.

According to an embodiment of the sample handling arrangement of the first aspect, each of the first portion and the second portion of the linear slide extends from the home sensor towards a location for the external track when the sample handling arrangement is operating in the second configuration. Further, the first portion of the linear slide is proximal to the external track and the second portion of the linear slide is distal to the external track when the sample handling arrangement is operating in the second configuration.

According to an embodiment of the sample handling arrangement of the first aspect, in the first mode, the pipetting module is configured to aspirate at a first aspirating position disposed within the automated analyzer. In the second mode, the pipetting module is configured to aspirate at least at a second aspirating position disposed outside the automated analyzer.

According to an embodiment of the sample handling arrangement of the first aspect, the sample handling arrangement further comprises a processor communicably coupled to the pipetting module. The processor is configured to control the pipetting module in order to switch the operation of the sample handling arrangement between the first configuration and the second configuration.

According to an embodiment of the sample handling arrangement of the first aspect, the processor is further configured to switch the operation of the sample handling arrangement between the first configuration and the second configuration outside of a manufacturing location of the automated analyzer.

According to an embodiment of the sample handling arrangement of the first aspect, the sample handling arrangement further comprises a non-volatile memory storing a set of instructions executable by the processor. The processor is further configured to execute the set of instructions to operate the sample handling arrangement in both the first configuration and the second configuration.

According to an embodiment of the sample handling arrangement of the first aspect, the sample handling arrangement further comprises the automated analyzer.

According to an embodiment of the sample handling arrangement of the first aspect, a throughput capacity of the automated analyzer is the same when the sample handling arrangement operates in the first configuration and the second configuration.

According to an embodiment of the sample handling arrangement of the first aspect, the external track is routed through a clinical laboratory. The automated analyzer is configured to be served by the sample handling arrangement, such that the pipetting module is operable in the first mode and/or in the second mode.

According to an embodiment of the sample handling arrangement of the first aspect, the automated analyzer is located within a clinical laboratory. The automated analyzer is configured to be served by the sample handling arrangement, such that the pipetting module is operable in the first mode.

According to a second aspect of the disclosure, a sample handling arrangement is provided for transferring at least one patient sample to at least one reaction vessel within an automated analyzer. The sample handling arrangement comprises a linear slide configured to be selectively mounted to a mount of the automated analyzer; and a pipetting module configured to travel along the linear slide, wherein the linear slide is configured to be statically mounted to the mount of the automated analyzer at a first position to define a first configuration of the sample handling arrangement, in which the pipetting module is confined to travel within the automated analyzer such that the pipetting module is configured to transfer the at least one patient sample from a first aspirating position disposed within the automated analyzer to the at least one reaction vessel and thereby operate in a first mode, wherein the linear slide is configured to be statically mounted to the mount of the automated analyzer at a second position different from the first position to define a second configuration of the sample handling arrangement, in which the pipetting module is configured to travel within and at least partially outside of the automated analyzer such that the pipetting module is configured to transfer the at least one patient sample from the first aspirating position to the at least one reaction vessel and thereby operate in the first mode, and such that the pipetting module is configured to transfer the at least one patient sample from a second aspirating position disposed outside the automated analyzer to the at least one reaction vessel and thereby operate in a second mode.

According to an embodiment of the sample handling arrangement of the second aspect, the second aspirating position is defined by an external track.

According to an embodiment of the sample handling arrangement of the second aspect, in the first mode, the pipetting module is configured to aspirate the at least one patient sample from at least one sample tube at the first aspirating position.

According to an embodiment of the sample handling arrangement of the second aspect, in the second mode, the pipetting module is configured to aspirate the at least one patient sample from at least one sample tube at the second aspirating position.

According to an embodiment of the sample handling arrangement of the second aspect, the sample handling arrangement further comprises a home sensor configured to determine whether the pipetting module is at a home position.

According to an embodiment of the sample handling arrangement of the second aspect, the home sensor is configured to be disposed at a fixed location relative to the mount of the automated analyzer, such that the home sensor is configured to remain at the fixed location when the linear slide is at each of the first and second positions.

According to an embodiment of the sample handling arrangement of the second aspect, the sample handling arrangement further comprises a processor communicably coupled to the pipetting module.

According to an embodiment of the sample handling arrangement of the second aspect, the sample handling arrangement further comprises a non-volatile memory storing a set of instructions executable by the processor, wherein the processor is configured to execute the set of instructions to control the pipetting module when the sample handling arrangement is in both the first configuration and the second configuration.

According to an embodiment of the sample handling arrangement of the second aspect, the sample handling arrangement further comprises the automated analyzer.

According to an embodiment of the sample handling arrangement of the second aspect, a throughput capacity of the automated analyzer is the same when the sample handling arrangement operates in the first configuration and the second configuration.

According to a third aspect of the disclosure, a method of handling at least one patient sample with a sample handling arrangement is provided. The method comprises selectively mounting a linear slide to a mount of an automated analyzer at a first position to define a rust configuration of the sample handling arrangement; while maintaining the linear slide at the first position, operating a pipetting module in a first mode such that the pipetting module travels along the linear slide within the automated analyzer to transfer the at least one patient sample from a first aspirating position disposed within the automated analyzer to at least one reaction vessel disposed within the automated analyzer, selectively mounting the linear slide to the mount of the automated analyzer at a second position different from the first position to define a second configuration of the sample handling arrangement; and while maintaining the linear slide at the second position, operating the pipetting module in at least one of the first mode such that the pipetting module travels along the linear slide within the automated analyzer to transfer the at least one patient sample from the first aspirating position to the at least one reaction vessel, or a second mode such that the pipetting module travels along the linear slide within and at least partially outside of the automated analyzer to transfer the at least one patient sample from a second aspirating position disposed outside the automated analyzer to the at least one reaction vessel.

According to an embodiment of the method of the third aspect, the method further comprises aspirating the at least one patient sample from at least one sample tube via the pipetting module at the first aspirating position.

According to an embodiment of the method of the third aspect, operating the pipetting module in at least one of the first mode or the second mode includes operating the pipetting module in the second mode such that the pipetting module travels along the linear slide within and at least partially outside of the automated analyzer to transfer the at least one patient sample from the second aspirating position to the at least one reaction vessel.

According to an embodiment of the method of the third aspect, the method further comprises aspirating the at least one patient sample from at least one sample tube via the pipetting module at the second aspirating position.

According to an embodiment of the method of the third aspect, the second aspirating position is defined by an external track.

According to an embodiment of the method of the third aspect, the method further comprises determining whether the pipetting module is at a home position via a home sensor.

According to an embodiment of the method of the third aspect, the home sensor is disposed at a fixed location relative to the mount of the automated analyzer, the method further comprising maintaining the home sensor at the fixed location when the linear slide is selectively mounted to the mount at each of the first and second positions.

According to an embodiment of the method of the third aspect, the method further comprises communicating with the pipetting module via a processor.

According to an embodiment of the method of the third aspect, the method further comprises executing a set of instructions stored by a non-volatile memory via the processor to control the pipetting module when the sample handling arrangement is in both the first configuration and the second configuration.

According to an embodiment of the method of the third aspect, the method further comprises operating the automated analyzer with a same throughput capacity while the sample handling arrangement is in the first configuration and while the sample handling arrangement is in the second configuration.

The pipetting module of the sample handling arrangement is selectively operable in the first mode and the second mode. Specifically, in the first mode, the pipetting module is configured to aspirate the one or more patient samples or portions thereof from the at least one sample tube held by the at least one rack within the automated analyzer and dispense the one or more aspirated patient samples into the at least one reaction vessel within the automated analyzer. In the second mode, the pipetting module is configured to aspirate the one or more patient samples or portions thereof from the external track and dispense the one or more patient samples or portions thereof into the at least one reaction vessel within the automated analyzer. Further, the sample handling arrangement is selectively operable in the first configuration and the second configuration. In the first configuration of the sample handling arrangement, the pipetting module is configured to travel only within the automated analyzer and thereby operate solely in the first mode. In the second configuration of the sample handling arrangement, the pipetting module is configured to travel within the automated analyzer and to the external track and thereby operate in the second mode. Further, in the second configuration of the sample handling arrangement, the pipetting module is also configured to travel within the automated analyzer and thereby also operate in the first mode.

Therefore, at one instance, the sample handling arrangement of the present disclosure enables the transfer of the one or more patient samples or portions thereof within the automated analyzer, and at another instance, the sample handling arrangement enables the transfer of the one or more patient samples or portions thereof from the external track to the at least one reaction vessel within the automated analyzer. In some cases, the sample handling arrangement may also enable the transfer of other fluids, such as reagents, buffer liquids, and so on from the external track to a vessel within the automated analyzer. Efficient switching between the two operating configurations (i.e., the first configuration and the second configuration) of the sample handling arrangement may reduce a turnaround time of the automated analyzer for testing the one or more patient samples or portions thereof. This may also increase an overall throughput speed and efficiency of the automated analyzer. Moreover, the sample handling arrangement may also be incorporated in a clinical analyzer outside of the manufacturing location of the clinical analyzer. This may ultimately provide an operator a customizable unit for transferring one or more samples from one place (within or outside the clinical analyzer) to another place (within the clinical analyzer).

The operation of the sample handling arrangement can be switched between the first configuration and the second configuration by selectively mounting the linear slide to the automated analyzer at the first position and the second position, respectively. As compared to conventional techniques for transferring the one or more patient samples or portions thereof from an external conveyor to the automated analyzer, the sample handling arrangement uses selective mounting of the linear slide at two different and interchangeable positions for switching the operation of the sample handling arrangement between the first configuration and the second configuration. In other words, the sample handling arrangement may not need additional components, such as additional pipetting mechanism, connectors, etc., which the conventional techniques require to transfer the one or more patient samples or portions thereof from the external track to the automated analyzer. Therefore, as compared to the conventional techniques, an overall cost of operation of the automated analyzer may increase only marginally or negligibly for incorporating the sample handling arrangement in an automated analyzer to enable switching the operation of the sample handling arrangement between the first configuration and the second configuration using the linear slide and the rail.

Furthermore, the operation of the sample handling arrangement can be switched between the first configuration and the second configuration by dismounting the linear slide at one of the first position and the second position and subsequently mounting the linear slide at the other of the first position and the second position. Therefore, the operation of the sample handling arrangement may be chosen in the first configuration or the second configuration based on different application requirements. Further, the operation of the sample handling arrangement of the present disclosure can be advantageously switched multiple times between the first configuration and the second configuration without installing or mounting any additional components. Moreover, in certain embodiments, the operation of the sample handling arrangement may be switched easily and quickly between the first configuration and the second configuration while performing real-time analysis of the one or more patient samples or portions thereof in a laboratory.

As the home sensor is configured to sense the presence or absence of the pipetting module at the home position, the home sensor is used as a position reference for sensing a movement of the pipetting module. In this way, a position of the pipetting module may be determined by the home sensor. Further, as the home sensor may be positioned along the second portion of the linear slide when the sample handling arrangement is operating in the second configuration, a controller may be informed of the pipetting module position when the sample handling arrangement is operating in the first configuration and the second configuration.

A variety of additional aspects will be set forth in the description that follows. These aspects can relate to individual features and to combinations of features. It is to be understood that both the foregoing summary and the following detailed description are exemplary and explanatory only and are not restrictive of the broad concepts upon which the embodiments disclosed herein are based.

### BRIEF DESCRIPTION OF THE FIGURES

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a block diagram of a sample handling arrangement, according to an embodiment of the present disclosure;

FIGS. 2A and 2B are schematic diagrams of the sample handling arrangement of FIG. 1 when the sample handling arrangement is operable in a first configuration, according to an embodiment of the present disclosure;

FIGS. 3A through 3D are schematic diagrams of the sample handling arrangement of FIG. 1 when the sample handling arrangement is operable in a second configuration, according to an embodiment of the present disclosure;

FIGS. 4A through 4D are schematic diagrams of the sample handling arrangement of FIG. 1, according to another embodiment of the present disclosure; and

FIG. 5 is a schematic diagram of the sample handling arrangement of FIG. 1 connecting two instruments, according to an embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

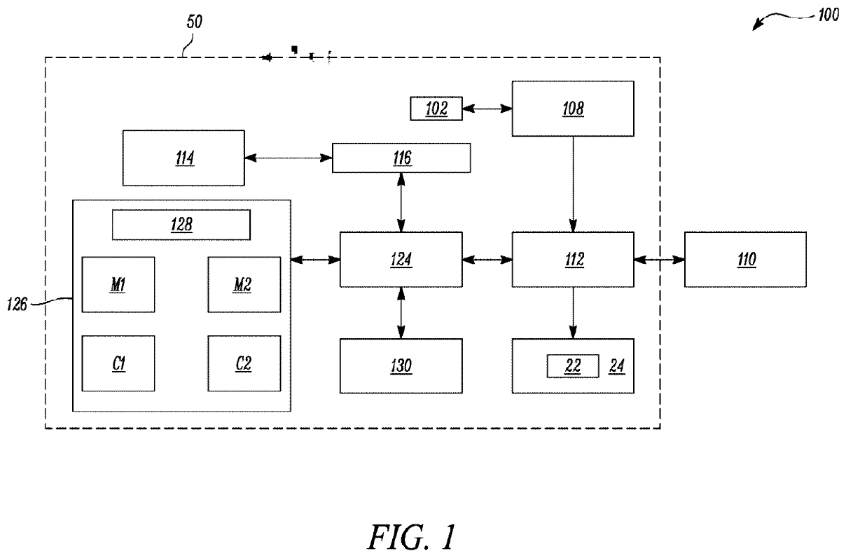

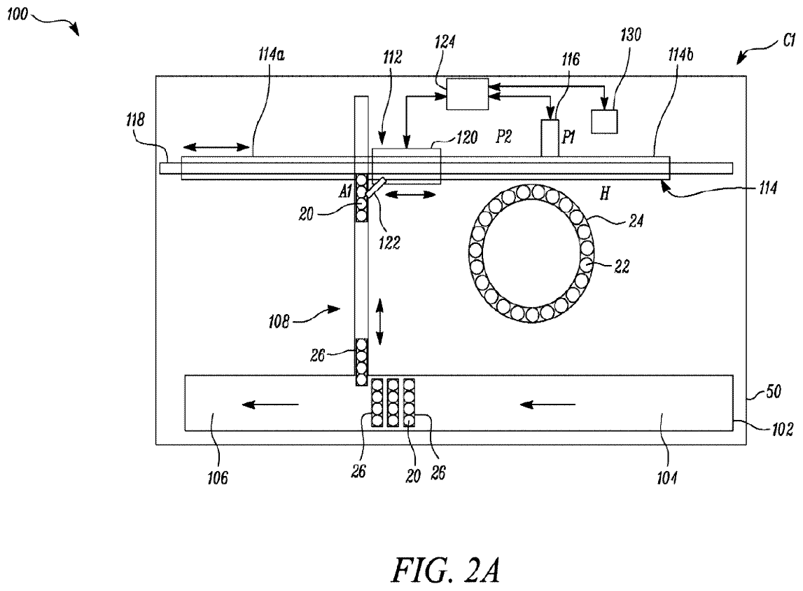

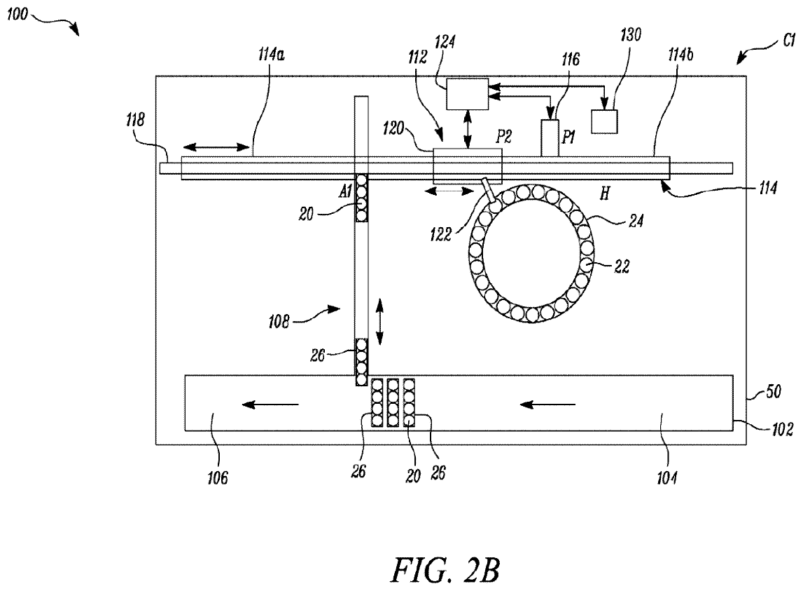

Referring now to the Figures, FIG. 1 is a block diagram of a sample handling arrangement 100, according to an embodiment of the present disclosure. Particularly, FIG. 1 is the block diagram of the sample handling arrangement 100 for transferring one or more patient samples or portions thereof from at least one sample tube 20 (shown at FIGS. 2A through 5) to at least one reaction vessel 22 within an automated analyzer 50. The at least one sample tube 20 (e.g., a patient sample tube) may be disposed within the automated analyzer 50 and/or outside the automated analyzer 50. The automated analyzer 50 includes a holding area 24 (e.g., a carousel) to hold the at least one reaction vessel 22. In some cases, the holding area 24 may also hold reagents, samples, or combination thereof. In some embodiments, the sample handling arrangement 100 may also transfer one or more fluids (e.g., blood, serum, plasma, blood fractions, joint fluid, urine, reagent, diluent, etc.) from one place to another. The automated analyzer 50 may be, for example, an immunoassay analyzer or a clinical chemistry analyzer. In some embodiments, the automated analyzer 50 is located within a clinical laboratory. In some embodiments, the automated analyzer 50 can be interchangeably referred to herein as “a first automated analyzer 50”.

FIGS. 2A and 2B are schematic diagrams of the sample handling arrangement 100 when the sample handling arrangement 100 is operable in a first configuration C1 (also shown at FIG. 1 and will be described later), according to an embodiment of the present disclosure. Referring to FIGS. 2A and 2B, the sample handling arrangement 100 includes a sample presentation unit 102 associated with the automated analyzer 50 and configured to receive a plurality of racks 26 and to introduce the racks 26 into the automated analyzer 50. Each of the plurality of racks 26 is configured to receive and hold the at least one sample tube 20. The sample presentation unit 102 includes a rack loading unit 104 and a rack unloading unit 106. In the illustrated embodiment of FIGS. 2A and 2B, only a few parts of the automated analyzer 50 are shown. The automated analyzer 50 may also include other components, such as feeder units, a wash wheel, reagent bottles, a reagent disk, etc. These components are not shown at FIGS. 2A and 2B for illustrative purposes.

The sample handling arrangement 100 further includes a rack transfer module 108 operatively coupled to the sample presentation unit 102. At least one rack 26 from the plurality of racks 26 may be transported from the rack loading unit 104 to the rack transfer module 108 by a pusher, a robotic arm, a positioner unit, etc. (not shown). The rack transfer module 108 may include a track with a transfer device, conveyor belts, etc. (not shown), such that the rack transfer module 108 moves the at least one rack 26 from one position to another position. In some cases, the rack transfer module 108 may include a chain, a carriage, a lead screw, a linear motor, or combinations thereof, such that the rack transfer module 108 moves the at least one rack 26 from one position to another position. In some cases, the rack transfer module 108 may include a motor (stepper motor or servo motor) to move the at least one rack 26.

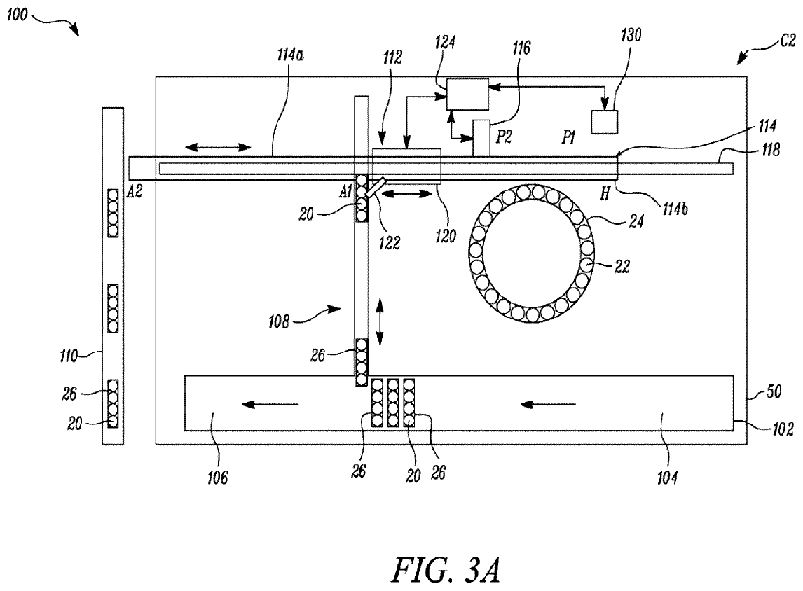

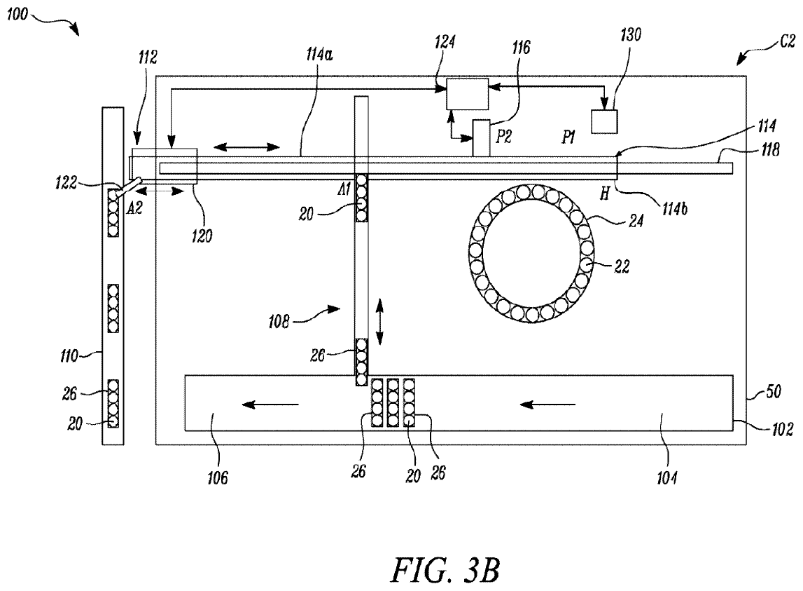

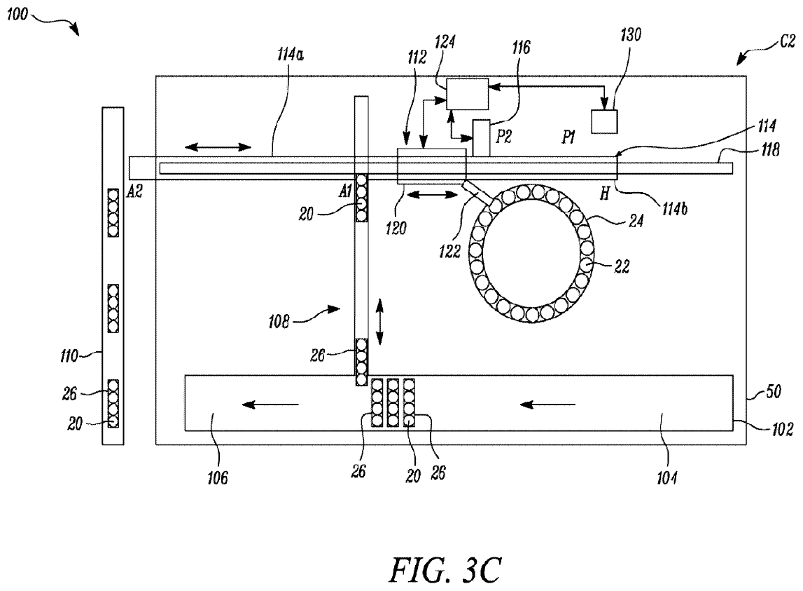

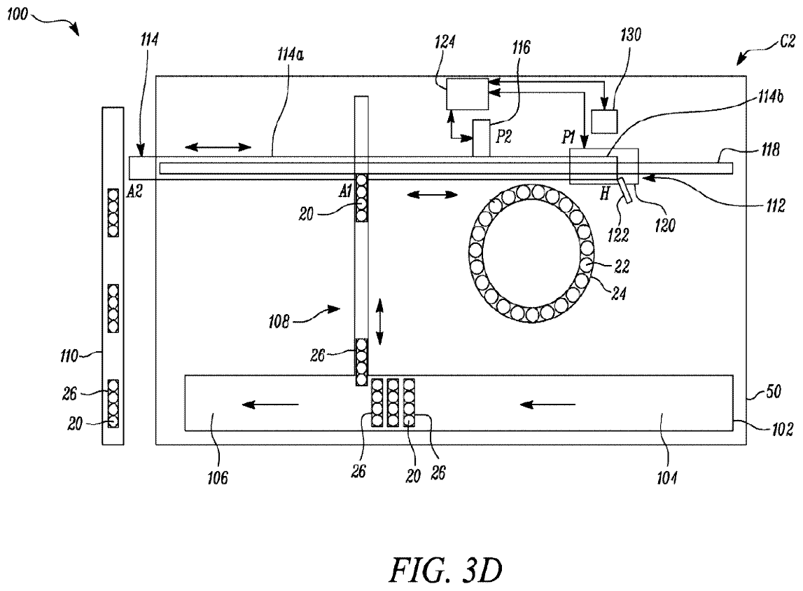

The sample handling arrangement 100 may further include an external track 110 (shown at FIGS. 3A through 3D) disposed outside the automated analyzer 50. The external track 110 may include a moving conveyor to transport the at least one rack 26 configured to receive and hold the at least one sample tube 20 and/or at least one puck (not shown) to receive and hold one of the sample tubes 20. In some cases, the external track 110 may also hold and transport other tubes containing diluents, reagents, or combination thereof. In some embodiments, the external track 110 is routed through the clinical laboratory. The external track 110 may be connected to a laboratory conveyor system including multiple instruments and control units for preparing the one or more patient samples or portions thereof, reagents, wash buffers, and the like.

The sample handling arrangement 100 further includes a pipetting module 112 configured to transfer the one or more patient samples or portions thereof to the at least one reaction vessel 22 within the automated analyzer 50. The rack transfer module 108 is configured to transfer at least one rack 26 from the plurality of racks 26 from the sample presentation unit 102 to the pipetting module 112 within the automated analyzer 50.

The sample handling arrangement 100 further includes a linear slide 114 configured to be selectively mounted to a mount 118 of the automated analyzer 50 at a first position P1 and a second position P2 different from the first position P1. Specifically, the linear slide 114 is adjustably mounted to the automated analyzer 50 for positioning at either the first position P1 or the second position P2. In certain embodiments, the linear slide 114 may be removably mounted to the automated analyzer 50 at either the first position P1 or the second position P2. In the illustrated embodiment of FIGS. 2A and 2B, the linear slide 114 is mounted to the mount 118 of the automated analyzer 50 at the first position P1. In the depicted embodiment, the mount 118 includes a rail along which the linear slide 114 is configured to be positioned at either the first position P1 or the second position P2. and the sample handling arrangement 100 further includes a position selector 116 configured to selectively position and mount the linear slide 114 at either the first position P1 or the second position P2. The position selector 116 may include an actuator, a toggle, a robotic device, a lifting arm, etc. The rail of the mount 118 facilitates selective positioning of the linear slide 114 between the first position P1 and the second position P2 and the mounting of the linear slide 114 at positions P1 and P2. In certain embodiments, the mount 118 includes a base plate that is secured to or part of a frame of the automated analyzer 50, and positional pins secure the linear slide 114 to the base plate at the first position P1 or the second position P2.

The pipetting module 112 is configured to travel along the linear slide 114. The pipetting module 112 further includes a carriage 120 configured to travel along the linear slide 114. A motor, such as a stepper motor, may move the carriage 120 along the linear slide 114. The pipetting module 112 further includes a probe 122 configured to aspirate at least a portion of the one or more patient samples from the at least one sample tube 20 and dispense the aspirated one or more patient samples or portions thereof into the at least one reaction vessel 22 within the automated analyzer 50. The carriage 120 may be slidably mounted on the linear slide 114 to allow movement of the carriage 120 relative to the linear slide 114. In some cases, the carriage 120 and the linear slide 114 may include complementary projection and channel to allow movement of the carriage 120 along the linear slide 114. In the illustrated embodiment of FIGS. 2A and 2B, the pipetting module 112 and the rack transfer module 108 travel linearly and perpendicularly to each other.

The sample handling arrangement 100 further includes a processor 124 communicably coupled to the pipetting module 112. In certain embodiments, the processor 124 is further communicably coupled to the position selector 116 in order to switch the mounting positions of the linear slide 114 between the first position P1 and the second position P2. The sample handling arrangement 100 further includes a non-volatile memory 126 storing a set of instructions 128 executable by the processor 124. The processor 124 is further configured to execute the set of instructions 128 to perform various functions which will be described later.

The processor 124 may be a programmable analog and/or digital device that can store, retrieve, and process data. In an application, the processor 124 may be a controller, a control circuit, a computer, a workstation, a microprocessor, a microcomputer, a central processing unit, a server, or any suitable device or apparatus.

With continued reference to FIGS. 1 through 2C, the pipetting module 112 is operable in a first mode M1 (the parameters of which may be stored in the non-volatile memory 126, as shown at FIG. 1) in which the pipetting module 112 is configured to transfer the one or more patient samples or portions thereof from the at least one sample tube 20 held by the at least one rack 26 within the automated analyzer 50 to the at least one reaction vessel 22 within the automated analyzer 50. Particularly, as shown at FIG. 2A, in the first mode M1, the pipetting module 112 is configured to aspirate the one or more patient samples or portions thereof from the at least one sample tube 20 at a first aspirating position A1 disposed within the automated analyzer 50. As shown at FIG. 2B, in the first mode M1, the pipetting module 112 is configured to dispense the one or more aspirated patient samples or portions thereof into the at least one reaction vessel 22 within the automated analyzer 50. Therefore, when the pipetting module 112 is operating in the first mode M1, it cannot aspirate the one or more patient samples or portions thereof from the external track 110 (shown at FIGS. 3A and 3B). In some embodiments, the automated analyzer 50 is served by the sample handling arrangement 100, such that the pipetting module 112 is operating in the first mode M1.

Further, the sample handling arrangement 100 is operable in the first configuration C1 (the parameters of which may also be stored in the non-volatile memory 126, as shown at FIG. 1) in which the pipetting module 112 is configured to travel within the automated analyzer 50 and thereby operate solely in the first mode M1. In other words, when the sample handling arrangement 100 is operating in the first configuration C1, the pipetting module 112 can travel within the automated analyzer 50 and thereby transfer the one or more patient samples or portions thereof from the at least one sample tube 20 held by the at least one rack 26 within the automated analyzer 50 to the at least one reaction vessel 22 within the automated analyzer 50. The processor 124 is further configured to execute the set of instructions 128 to operate the sample handling arrangement 100 in the first configuration C1.

The linear slide 114 is mounted to the automated analyzer 50 at the first position P1 when the sample handling arrangement 100 is operating in the first configuration C1. Therefore, when the linear slide 114 is mounted to the automated analyzer 50 at the first position P1 (i.e., operation of the sample handling arrangement 100 in the first configuration C1), the pipetting module 112 is configured to operate in the first mode M1 and travel along the linear slide 114 in order to transfer the one or more samples or portions thereof from the at least one sample tube 20 held by the at least one rack 26 within the automated analyzer 50 to the at least one reaction vessel 22 within the automated analyzer 50. Further, the linear slide 114 is secured to the rail, base plate, etc. of the mount 118 when the sample handling arrangement 100 is operating in the first configuration C1. The linear slide 114 is stationary when the sample handling arrangement 100 is operating in the first configuration C1. This means that the linear slide 114 does not travel along the rail, base plate, etc. of the mount 118 during the operation of the sample handling arrangement 100 in the first configuration C1. Moreover, when the sample handling arrangement 100 is operating in the first configuration C1, the linear slide 114 does not extend outside the automated analyzer 50 towards the external track 110 (shown at FIG. 3A) and therefore, the pipetting module 112 does not travel outside the automated analyzer 50 to aspirate the one or more patient samples or portions thereof from the external track 110. In some cases, the linear slide 114 may be removably mounted on and secured to the rail, base plate, etc. of the mount 118 by one or more fasteners, electromagnetic coupling, and so forth.

The sample handling arrangement 100 further includes a home sensor 130 for sensing the presence or absence of the pipetting module 112 at a home position H. In other words, the home sensor 130 is used for homing the pipetting module 112. A physical location of the home sensor 130 may be unchanged when the sample handling arrangement 100 is operating in the first configuration C1. In some embodiments, the home sensor 130 may be a proximity sensor, a magnetic sensor, or a capacitive sensor. In other embodiments, the home sensor 130 may be a slotted optical sensor or a limit switch.

The linear slide 114 further includes a first portion 114a and a second portion 114b along its length. When the sample handling arrangement 100 is operating in the first configuration C1, the first portion 114a of the linear slide 114 extends from the home sensor 130 towards a location for the external track 110 (shown at FIG. 3A). Further, when the sample handling arrangement 100 is operating in the first configuration C1, the second portion 114b of the linear slide 114 extends from adjacent the home sensor 130 opposite to the first portion 114a. In the illustrated embodiment of FIGS. 2A and 2B, the first portion 114a has a length greater than that of the second portion 114b. The carriage 120 does not travel on the second portion 114b of the linear slide 114 when the sample handling arrangement 100 is operating in the first configuration C1, such that the second portion 114b corresponds to an unused (i.e., non-used) portion of the linear slide 114 in the first configuration C1 of the sample handling arrangement 100. In other words, when the sample handling arrangement 100 is operating in the first configuration C1, the pipetting module 112 does not travel on the second portion 114b of the linear slide 114. In other embodiments, the home sensor 130 may be positioned at other locations. In certain embodiments, the home sensor 130 detects the presence of a target that is positioned on the carriage 120.

Further, the sample handling arrangement 100 is operable in a second configuration C2 (the parameters of which may be stored in the non-volatile memory 126 at FIG. 1) in which the pipetting module 112 is configured to travel within the automated analyzer 50 and to the external track 110. FIGS. 3A through 3D are schematic diagrams of the sample handling arrangement 100 when the sample handling arrangement is operable in the second configuration C2 (the parameters of which may also be stored in the non-volatile memory 126 at FIG. 1), according to an embodiment of the present disclosure. The pipetting module 112 and the external track 110 may travel perpendicularly to each other adjacent to a point of intersection of the pipetting module 112 and the external track 110. The processor 124 is further configured to execute the set of instructions 128 to operate the sample handling arrangement 100 in the second configuration C2. Therefore, the processor 124 is configured to execute the set of instructions 128 to operate the sample handling arrangement 100 in both the first configuration C1 (corresponding to FIGS. 2A and 2B) and the second configuration C2 (corresponding to FIGS. 3A through 3D).

Referring to FIG. 3B, the pipetting module 112 is operable in a second mode M2 (the parameters of which may be stored in the non-volatile memory 126 at FIG. 1) in which the pipetting module 112 is configured to transfer the one or more patient samples or portions thereof from the external track 110 disposed outside the automated analyzer 50 to the at least one reaction vessel 22 within the automated analyzer 50. Therefore, as shown at FIG. 3B, the sample handling arrangement 100 is operable in the second configuration C2 in which the pipetting module 112 is configured to travel within the automated analyzer 50 and to the external track 110 and thereby operate in the second mode M2. Referring to FIG. 3A, the sample handling arrangement 100 is operable in the second configuration C2 and the pipetting module 112 is configured to operate in the first mode M1 as the pipetting module 112 is configured to aspirate the one or more patient samples or portions thereof at the first aspirating position A1 disposed within the automated analyzer 50. Therefore, the sample handling arrangement 100 is operable in the second configuration C2 in which the pipetting module 112 is further configured to travel within the automated analyzer 50 and to the at least one rack 26 transferred by the rack transfer module 108 within the automated analyzer 50 and thereby also operate in the first mode M1. Referring to FIGS. 3A and 3B, it can be concluded that when the sample handling arrangement 100 is operable in the second configuration C2, the pipetting module 112 is configured to operate in the first mode M1 and/or the second mode M2. In some embodiments, the automated analyzer 50 is served by the sample handling arrangement 100, such that the pipetting module 112 is operating in the first mode M1 and/or the second mode M2. As shown at FIG. 3D, sample handling arrangement 100 is operable in the second configuration C2 in which the carriage 120 of the pipetting module 112 is illustrated as disposed at the home position H.

As shown at FIG. 3A, in the first mode M1, the pipetting module 112 is configured to aspirate the one or more patient samples or portions thereof from the at least one sample tube 20 at the first aspirating position A1 disposed within the automated analyzer 50. As shown at FIG. 3B, in the second mode M2, the pipetting module 112 aspirates at a second aspirating position A2 disposed outside the automated analyzer 50. As shown at FIG. 3C, the pipetting module 112 is configured to dispense the one or more aspirated patient samples into the at least one reaction vessel 22 within the automated analyzer 50. Therefore, when the pipetting module 112 is operating in the second mode M2, it may aspirate the one or more patient samples or portions thereof from the external track 110.

Referring to FIGS. 3A through 3D, the linear slide 114 is mounted to the automated analyzer 50 at the second position P2 when the sample handling arrangement 100 is operating in the second configuration C2. Therefore, when the linear slide 114 is mounted to the automated analyzer 50 at the second position P2 (i.e., operation of the sample handling arrangement 100 in the second configuration C2), the pipetting module 112 is configured to operate in the first mode M1 and/or the second mode M2. Further, the linear slide 114 is secured to the rail, base plate, etc. of the mount 118 when the sample handling arrangement 100 is operating in the second configuration C2. Therefore, the linear slide 114 is secured to the rail, base plate, etc. of the mount 118 when the sample handling arrangement 100 is operating in each of the first configuration C1 (corresponding to FIGS. 2A and 2B) and the second configuration C2. The linear slide 114 is stationary when the sample handling arrangement 100 is operating in the second configuration C2. Therefore, the linear slide 114 is stationary when the sample handling arrangement 100 is operating in each of the first configuration C1 (corresponding to FIGS. 2A and 2B) and the second configuration C2. This means that the linear slide 114 does not travel along the rail, base plate, etc. of the mount 118 during the operation of the sample handling arrangement 100 in each of the first configuration C1 and the second configuration C2. When the sample handling arrangement 100 is operating in the second configuration C2, the linear slide 114 extends outside the automated analyzer 50 towards the external track 110 and therefore, the pipetting module 112 can also travel outside the automated analyzer 50 to aspirate the one or more patient samples or portions thereof from the external track 110.

Furthermore, the physical location of the home sensor 130 is unchanged when the sample handling arrangement 100 is operating in the second configuration C2. Therefore, the physical location of the home sensor 130 is unchanged when the sample handling arrangement 100 is operating in the first configuration C1 (corresponding to FIGS. 2A and 2B) as well as when the sample handling arrangement 100 is operating in the second configuration C2. The home sensor 130 may be positioned along the second portion 114b of the linear slide 114 when the sample handling arrangement 100 is operating in the second configuration C2. When the sample handling arrangement 100 is operating in the second configuration C2, each of the first portion 114a and the second portion 114b of the linear slide 114 may extend from the home sensor 130 towards a location for the external track 110. Further, when the sample handling arrangement 100 is operating in the second configuration C2, the first portion 114a of the linear slide 114 may be proximal to the external track 110 and the second portion 114b of the linear slide 114 may be distal to the external track 110.

The carriage 120 travels on the first portion 114a and the second portion 114b of the linear slide 114 when the sample handling arrangement 100 is operating in the second configuration C2. Therefore, contrary to the operation of the sample handling arrangement 100 in the first configuration C1 (corresponding to FIGS. 2A and 2B), the carriage 120 also travels on the second portion 114b of the linear slide 114 when the sample handling arrangement 100 is operating in the second configuration C2.

Referring now to FIGS. 1 through 3D, the processor 124 may be configured to control the pipetting module 112 and/or the position selector 116 in order to switch the operation of the sample handling arrangement 100 between the first configuration C1 and the second configuration C2. In other words, for switching the operation of the sample handling arrangement 100 from the first configuration C1 to the second configuration C2, the processor 124 may control the position selector 116 to mount the linear slide 114 at the second position P2 and then control the pipetting module 112, such that the pipetting module 112 travels within the automated analyzer 50 and to the external track 110. Further, for switching the operation of the sample handling arrangement 100 from the second configuration C2 to the first configuration C1, the processor 124 may control the position selector 116 to mount the linear slide 114 at the first position P1 and then control the pipetting module 112, such that the pipetting module 112 travels solely within the automated analyzer 50. Therefore, the linear slide 114 may be dismounted at one of the first position P1 and the second position P2 and subsequently mounted at the other of the first position P1 and the second position P2 in order to switch the operation of the sample handling arrangement 100 between the first configuration C1 and the second configuration C2. For example, the linear slide 114 is dismounted at the first position P1 and subsequently remounted at the second position P2 in order to switch the operation of the sample handling arrangement 100 from the first configuration C1 to the second configuration C2. The pipetting module 112 may also move along with the linear slide 114 when the linear slide 114 is selectively mounted to the rail, base plate, etc. of the mount 118 at the first and second positions P1. P2. Tn some embodiments, the position selector 116 may be absent, and the linear slide 114 may be manually dismounted at one of the first position P1 and the second position P2 and then manually remounted at the other of the first position P1 and the second position P2.

In some embodiments, the processor 124 is further configured to switch the operation of the sample handling arrangement 100 between the first configuration C1 and the second configuration C2 outside of a manufacturing location of the automated analyzer 50. Therefore, the sample handling arrangement 100 may be used with any automated analyzer irrespective of a manufacturing location of that automated analyzer. In some embodiments, a throughput capacity of the automated analyzer 50 is the same when the sample handling arrangement 100 operates in the first configuration C1 or the second configuration C2.

With continued reference to FIGS. 1 through 3D, the pipetting module 112 may be selectively operable in the first mode M1 and the second mode M2. In other words, in the first mode M1, the pipetting module 112 is configured to aspirate the one or more patient samples or portions thereof from the at least one sample tube 20 held by the at least one rack 26 within the automated analyzer 50 and dispense the one or more aspirated patient samples into the at least one reaction vessel 22 within the automated analyzer 50. In the second mode M2, the pipetting module 112 is configured to aspirate the one or more patient samples or portions thereof from the external track 110 and dispense the one or more aspirated patient samples into the at least one reaction vessel 22 within the automated analyzer 50. Further, the sample handling arrangement 100 is selectively operable in the first configuration C1 and the second configuration C2.

Therefore, on one hand, the sample handling arrangement 100 enables the transfer of the one or more patient samples or portions thereof within the automated analyzer 50, and on the other hand, the sample handling arrangement 100 enables the transfer of the one or more patient samples or portions thereof from the external track 110 to the least one reaction vessel 22 within the automated analyzer 50. In some cases, the sample handling arrangement 100 may also enable the transfer of other fluids, such as reagents, buffer liquids, and so on from the external track 110 to a vessel within the automated analyzer 50. The two operating configurations (i.e., the first configuration C1 and the second configuration C2) of the sample handling arrangement 100 may reduce a turnaround time of the automated analyzer 50 for testing the one or more patient samples or portions thereof. This may also increase a throughput speed and efficiency of the automated analyzer 50. Moreover, the sample handling arrangement 100 may also be incorporated in a clinical analyzer outside of the manufacturing location of the clinical analyzer. This may ultimately provide an operator a customizable unit for transferring one or more samples from one place (within or outside the clinical analyzer) to another place (within the clinical analyzer).

The operation of the sample handling arrangement 100 can be switched between the first configuration C1 and the second configuration C2 by selectively mounting the linear slide 114 to the automated analyzer 50 at the first position P1 and the second position P2, respectively. As compared to conventional techniques for transferring the one or more patient samples or portions thereof from an external conveyor to the automated analyzer, the sample handling arrangement 100 may use only selective mounting of the linear slide 114 at two different and interchangeable positions for switching the operation of the sample handling arrangement 100 between the first configuration C1 and the second configuration C2. In other words, the sample handling arrangement 100 does not need additional components, such as additional pipetting mechanism, connectors, etc., which conventional techniques may require to transfer the one or more patient samples or portions thereof from the external track 110 to the automated analyzer 50. Therefore, as compared to the conventional techniques, an overall cost of operation of the automated analyzer 50 may increase only marginally for incorporating the sample handling arrangement 100 in an automated analyzer to enable switching the operation of the sample handling arrangement 100 between the first configuration C1 and the second configuration C2 using the linear slide 114 and the rail, base plate, etc. of the mount 118. In certain embodiments, additional housing (i.e., cabinet) panels, adapters, etc. may be needed to enclose the sample handling arrangement 100. In certain embodiments, at least some of the housing components may be reconfigured and thereby used in both of the first configuration C1 and the second configuration C2.

Furthermore, as already stated above, the operation of the sample handling arrangement 100 can be switched between the first configuration C1 and the second configuration C2 by dismounting the linear slide 114 at one of the first position P1 and the second position P2 and subsequently remounting the linear slide 114 at the other of the first position P1 and the second position P2. Therefore, the operation of the sample handling arrangement 100 may be chosen in the first configuration C1 or the second configuration C2 based on different application requirements. Further, the operation of the sample handling arrangement 100 of the present disclosure can be advantageously switched multiple times between the first configuration C1 and the second configuration C2 without installing or mounting any additional components or at least any additional components of the sample handling arrangement 100. Moreover, the operation of the sample handling arrangement 100 may be switched easily and quickly between the first configuration C1 and the second configuration C2 while performing real-time analysis of the one or more patient samples or portions thereof in a laboratory.

As the home sensor 130 is configured to sense the presence or absence of the pipetting module 112 (e.g., the carriage 120) at the home position H, the home sensor 130 is used as a position reference for sensing a movement of the pipetting module 112. In this way, a position of the pipetting module 112 may be determined by the home sensor 130. Further, as the home sensor 130 may be positioned along the second portion 114b of the linear slide 114 when the sample handling arrangement 100 is operating in the second configuration C2, an operator may be informed whether the sample handling arrangement 100 is operating in the first configuration C1 or the second configuration C2. Through this information, the operator and/or the controller (e.g., the processor 124) may plan upcoming steps of analysis in a better way according to the application requirements.

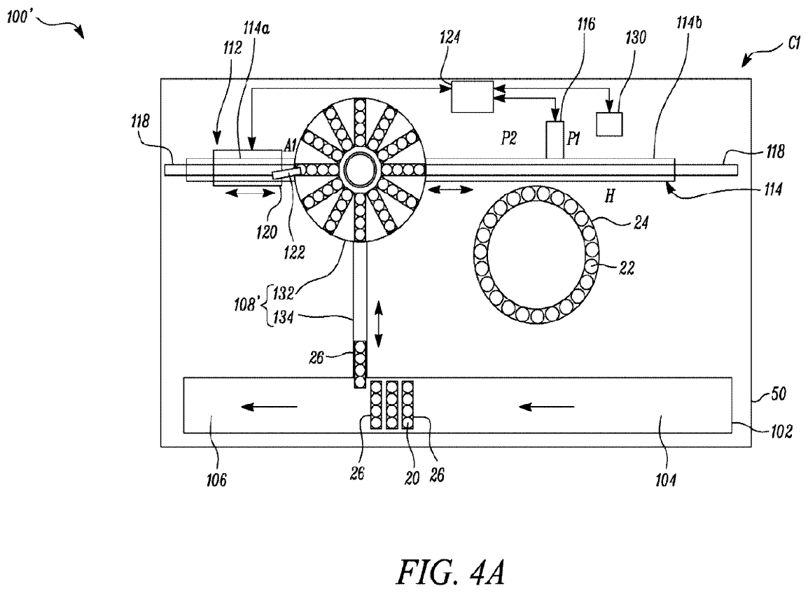

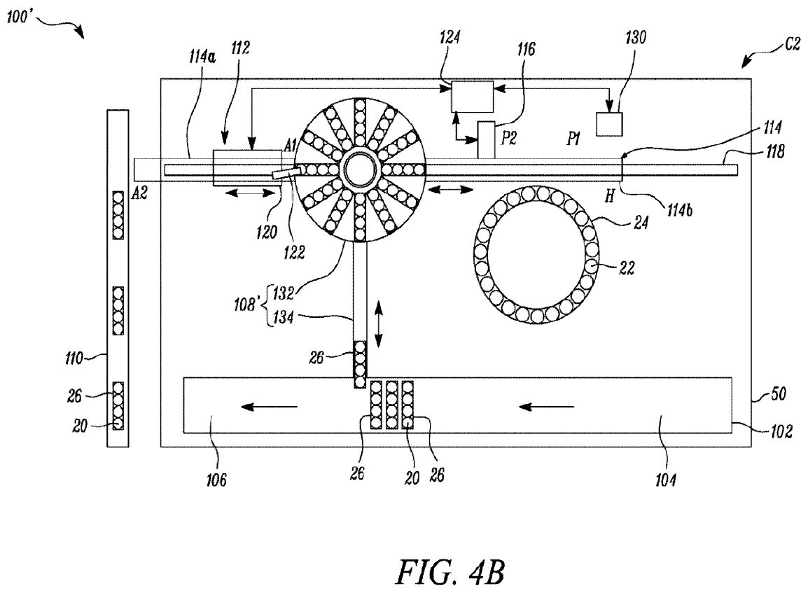

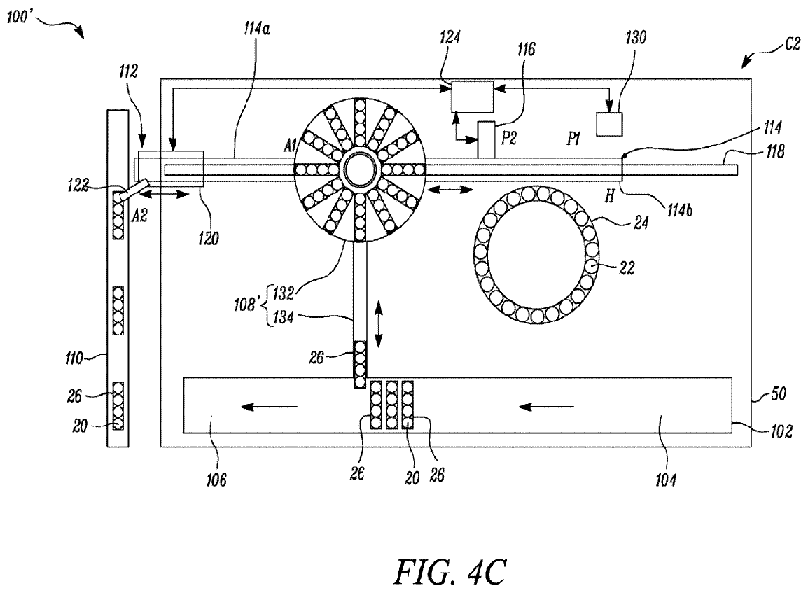

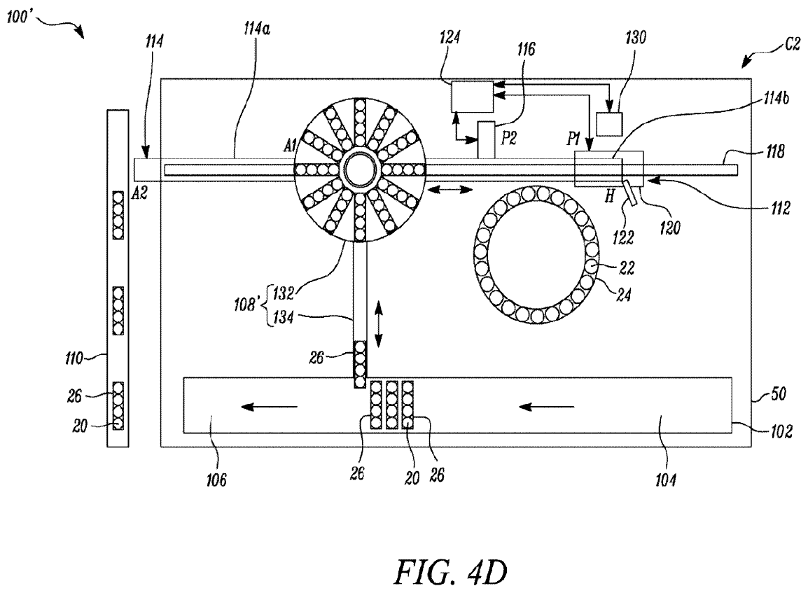

FIGS. 4A through 4D are schematic diagrams of a sample handling arrangement 100′, according to another embodiment of the present disclosure. The sample handling arrangement 100′ is substantially similar to the sample handling arrangement 100 illustrated at FIGS. 2A through 3C, with common components being referred to by the same reference numerals. However, the sample handling arrangement 100′ includes a rack transfer module 108′ that is functionally equivalent to the rack transfer module 108 (shown at FIG. 2A) of the sample handling arrangement 100. The rack transfer module 108′ includes a linear transport line 134 configured to receive the at least one rack 26 from the sample presentation unit 102. The rack transfer module 108′ further includes a rack rotor 132 configured to transfer the at least one rack 26 from the linear transport line 134 to the pipetting module 112 within the automated analyzer 50. The rack rotor 132 is operatively connected to the linear transport line 134 as well as the pipetting module 112 that is configured to travel along the linear slide 114.

As shown at FIG. 4A, the sample handling arrangement 100′ is operable in the first configuration C1 in which the pipetting module 112 is configured to travel within the automated analyzer 50 and thereby operate solely in the first mode M1. As shown at FIGS. 4B and 4C, the sample handling arrangement 100′ is operable in the second configuration C2 in which the pipetting module 112 is configured to travel within the automated analyzer 50 and to the external track 110 and thereby operate in the second mode M2. As shown at FIG. 4B, the sample handling arrangement 100′ is operable in the second configuration C2 in which the pipetting module 112 is further configured to travel within the automated analyzer 50 and to the at least one rack 26 transferred by the rack transfer module 108′ within the automated analyzer 50 and thereby also operate in the first mode M1. A functional advantage of the sample handling arrangement 100′ is substantially the same as that of the sample handling arrangement 100 illustrated at FIGS. 2A through 3C. As shown at FIG. 4D, the sample handling arrangement 100′ is operable in the second configuration C2 in which the carriage 120 of the pipetting module 112 is illustrated as disposed at the home position H.

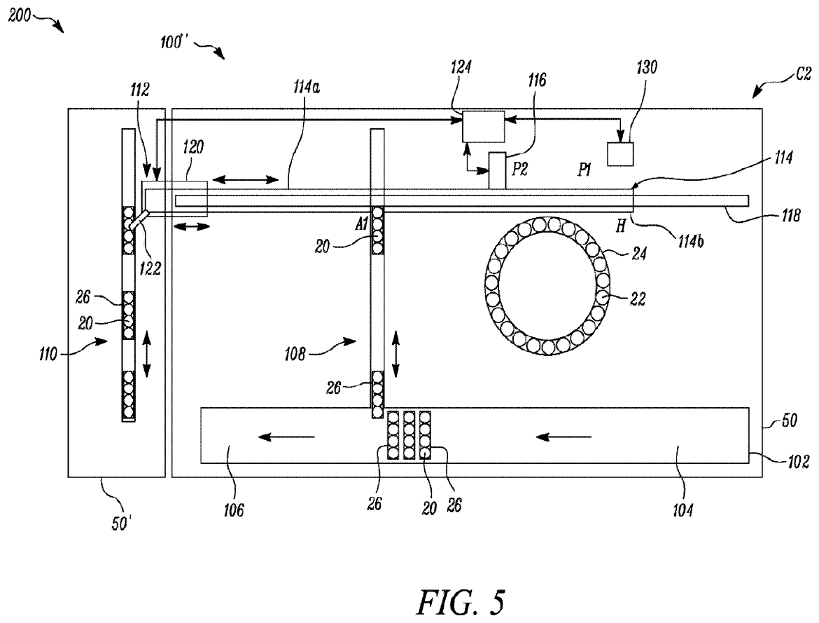

FIG. 5 illustrates a combination analyzer 200 comprising a sample handling arrangement 100″ (similar to the sample handling arrangement 100, shown at FIG. 2A), according to an embodiment of the present disclosure. The combination analyzer 200 further includes the first automated analyzer 50 and a second automated analyzer 50′. In some embodiments, the first automated analyzer 50 is an immunoassay analyzer. The second automated analyzer 50′ may be a mass spectrometer analyzer and/or include a mass spectrometer (not shown). The second automated analyzer 50′ may be a clinical chemistry analyzer and/or include a clinical chemistry analyzer (not shown). In the combination analyzer 200, at least a portion of the external track 110 is disposed within the second automated analyzer 50′. In some embodiments, the external track 110 may be a rack transfer module or a conveyor lane disposed within the second automated analyzer 50′.

As shown at FIG. 5, the sample handling arrangement 100″ is operable in the second configuration C2 in which the pipetting module 112 is configured to travel within the automated analyzer 50 and to the external track 110 and thereby operate in the second mode M2. In some embodiments, the pipetting module 112 may also aspirate other fluids as well in addition to the one or more patient samples or portions thereof from the external track 110. For example, when the sample handling arrangement 100″ is operating in the second configuration C2, the pipetting module 112 may be configured to access various one or more aspiration locations within the second automated analyzer 50′. Therefore, the sample handling arrangement 100″ may facilitate aspiration of sample liquids from the second automated analyzer 50′ and dispensation of the aspirated sample liquids into the at least one reaction vessel 22 within the automated analyzer 50, and vice versa. Moreover, in the combination analyzer 200, it is apparent that the sample handling arrangement 100″ is also operable in the first configuration C1 as well in which the pipetting module 112 is configured to travel within the automated analyzer 50 and thereby operate solely in the first mode M1.

For the purposes of this disclosure, “may” and “may be” are intended to include “configured to” and “configured to be,” respectively. For example, the above description that the pipetting module 112 and the external track 110 may travel perpendicularly to each other adjacent to a point of intersection of the pipetting module 112 and the external track 110 includes instances in which the pipetting module 112 and the external track 110 are configured to travel perpendicularly to each other adjacent to a point of intersection of the pipetting module 112 and the external track 110. As another example, the above description that the linear slide 114 may be removably mounted to the automated analyzer 50 at either the first position P1 or the second position P2 includes instances in which the linear slide 114 is configured to be removably mounted to the automated analyzer 50 at either the first position P1 or the second position P2.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1-40. (canceled)

41. A sample handling arrangement for transferring at least a portion of one or more patient samples from at least one sample tube to at least one reaction vessel within an automated analyzer, the sample handling arrangement comprising:
(a) a sample presentation unit associated with the automated analyzer and configured to receive a plurality of racks into the automated analyzer, each of the plurality of racks configured to receive and hold the at least one sample tube;
(b) a linear slide configured to be selectively mounted to a mount of the automated analyzer at a first position and a second position different from the first position;
(c) a pipetting module configured to transfer at least the portion of the one or more patient samples to the at least one reaction vessel within the automated analyzer, wherein the pipetting module is configured to travel along the linear slide;
(d) a rack transfer module operatively coupled to the sample presentation unit and configured to transfer at least one rack of the plurality of racks from the sample presentation unit to the pipetting module within the automated analyzer; and
(e) a home sensor for sensing the presence or absence of the pipetting module at a home position;
wherein the pipetting module is operable in:
(i) a first mode in which the pipetting module is configured to transfer at least the portion of the one or more patient samples from the at least one sample tube held by the at least one rack within the automated analyzer to the at least one reaction vessel within the automated analyzer; and
(ii) a second mode in which the pipetting module is configured to transfer at least the portion of the one or more patient samples from an external track disposed outside the automated analyzer to the at least one reaction vessel within the automated analyzer;
wherein the sample handling arrangement is operable in:
(i) a first configuration in which the pipetting module is configured to travel within the automated analyzer and thereby operate solely in the first mode; and
(ii) a second configuration in which:
(A) the pipetting module is configured to travel within the automated analyzer and to the external track and thereby operate in the second mode; and
(B) the pipetting module is further configured to travel within the automated analyzer and to the at least one rack transferred by the rack transfer module within the automated analyzer and thereby also operate in the first mode;
wherein the linear slide is configured to be mounted to the mount of the automated analyzer at the first position when the sample handling arrangement is operating in the first configuration, wherein the linear slide is configured to be mounted to the mount of the automated analyzer at the second position when the sample handling arrangement is operating in the second configuration, and wherein the linear slide is configured to be stationary when the sample handling arrangement is operating in each of the first configuration and the second configuration.

42. The sample handling arrangement of claim 41, wherein a physical location of the home sensor is configured to be unchanged when the sample handling arrangement is operating in the first configuration as well as when the sample handling arrangement is operating in the second configuration.

43. The sample handling arrangement of claim 42, wherein the rack transfer module further comprises:
(i) a linear transport line configured to receive the at least one rack from the sample presentation unit; and
(ii) a rack rotor configured to transfer the at least one rack from the linear transport line to the pipetting module within the automated analyzer.

44. The sample handling arrangement of claim 41, wherein the pipetting module and the rack transfer module travel linearly and perpendicularly to each other.

45. The sample handling arrangement of claim 41, further comprising the external track, wherein the pipetting module and the external track are configured to travel perpendicularly to each other adjacent to a point of intersection of the pipetting module and the external track.

46. The sample handling arrangement of claim 41, wherein the linear slide is configured to be dismounted at one of the first position and the second position and subsequently mounted at the other of the first position and the second position in order to switch operation of the sample handling arrangement between the first configuration and the second configuration.

47. The sample handling arrangement of claim 41, further comprising a position selector configured to selectively position and mount the linear slide at either the first position or the second position.

48. The sample handling arrangement of claim 41, wherein the mount comprises a rail along which the linear slide is configured to be positioned at either the first position or the second position, wherein the linear slide is configured to be secured to the rail when the sample handling arrangement is operating in each of the first configuration and the second configuration.

49. The sample handling arrangement of claim 41, wherein:
the pipetting module further comprises a carriage configured to travel along the linear slide;
the linear slide further comprises a first portion and a second portion;
the carriage is configured to travel on the first portion and the second portion of the linear slide when the sample handling arrangement is operating in the second configuration; and
the carriage is not configured to travel on the second portion of the linear slide when the sample handling arrangement is operating in the first configuration, such that the second portion defines an unused portion of the linear slide in the first configuration of the sample handling arrangement.

50. The sample handling arrangement of claim 49, wherein the home sensor is configured to be positioned along the second portion of the linear slide when the sample handling arrangement is operating in the second configuration.

51. The sample handling arrangement of claim 49, wherein when the sample handling arrangement is operating in the first configuration:
the first portion of the linear slide extends from the home sensor towards a location for the external track; and
the second portion of the linear slide extends from adjacent the home sensor opposite to the first portion.

52. The sample handling arrangement of claim 49, wherein when the sample handling arrangement is operating in the second configuration:
each of the first portion and the second portion of the linear slide extends from the home sensor towards a location for the external track; and
the first portion of the linear slide is proximal to the external track and the second portion of the linear slide is distal to the external track.

53. The sample handling arrangement of claim 41, wherein, in the first mode, the pipetting module is configured to aspirate at a first aspirating position disposed within the automated analyzer, and wherein, in the second mode, the pipetting module is configured to aspirate at a second aspirating position disposed outside the automated analyzer.

54. The sample handling arrangement of claim 41, further comprising a processor communicably coupled to the pipetting module, wherein the processor is configured to control the pipetting module in order to switch the operation of the sample handling arrangement between the first configuration and the second configuration.

55. The sample handling arrangement of claim 54, wherein the processor is further configured to switch the operation of the sample handling arrangement between the first configuration and the second configuration outside of a manufacturing location of the automated analyzer.

56. The sample handling arrangement of claim 54, further comprising a non-volatile memory storing a set of instructions executable by the processor, wherein the processor is further configured to execute the set of instructions to operate the sample handling arrangement in both the first configuration and the second configuration.

57. The sample handling arrangement of claim 41, further comprising the automated analyzer.

58. The sample handling arrangement of claim 57, wherein a throughput capacity of the automated analyzer is the same when the sample handling arrangement operates in the first configuration and the second configuration.

59. The sample handling arrangement of claim 57, wherein:
the external track is routed through a clinical laboratory; and
the automated analyzer is configured to be served by the sample handling arrangement, such that the pipetting module is operable in the first mode and/or in the second mode.

60. The sample handling arrangement of claim 57, wherein:
the automated analyzer is located within a clinical laboratory; and
the automated analyzer is configured to be served by the sample handling arrangement, such that the pipetting module is operable in the first mode.
